(19) United States
(12) Patent Application Publication
(10) Pub. No.: US 2009/0297321 A1
(43) Pub. Date: Dec. 3, 2009

(54) METHOD AND DEVICE FOR HOLDING TOGETHER AN ELECTRICALLY NON-CONDUCTIVE STACK OF OBJECTS AND AN ELECTRODE UNIT THEREOF

(75) Inventor: Johan Hendrik VREEMAN, Lochem (NL)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ILLINOIS TOOL WORKS INC., Glenview, IL (US)

(21) Appl. No.: 12/430,139

(22) Filed: Apr. 27, 2009

(30) Foreign Application Priority Data
May 29, 2008 (EP) 08009809.8

(51) Int. Cl. B65G 57/00; B65H 7/00; B65B 35/50; B65H 29/00

(52) U.S. Cl. 414/788; 414/801

(57) ABSTRACT

The invention relates to a method for holding together an electrically non-conductive stack of objects, such as a stack of magazines or foil strips, comprising the steps of:
i) forming the stack of objects; and
ii) applying along at least one stack surface at a distance D at least two regions having a difference in static polarity such that the stack of objects is held together, to a device for holding together an electrically non-conductive stack of objects, such as a stack of magazines or foil strips, comprising a station for a stack of objects, and at least two electrodes for applying along at least one stack surface at a distance D at least two regions having a difference in static polarity such that the stack of objects is held together, and power supplies for the respective electrodes and to an electrode unit therefore.

The present invention relates to a method and device for holding together an electrically non-conductive stack of objects, and to an electrode unit used in this method and device.

EP 1 741 652 discloses a method and device for holding together an electrically non-conductive stack of objects. The stack of objects may be a stack of magazines, which may vary in height from about 5 to about 50 cm. Prior to be bundled, the stack of magazines is transported and relative movement of the magazines in the stack is to be avoided. Another example of stacked objects is a stack of foil strips, for instance to be intended for a device for manufacturing plastic bags.

This prior art method and device apply static electricity to the stack of objects. The static polarity and a counter-polarity are applied to different surfaces. The differential polarity is generally from about 0 kV to about 120 kV. Under circumstances one of the polarities has the earthed polarity.

The present invention has for its object to further improve this method and device such that the stack of objects is hold together more firmly or hold together with the application of a smaller difference in polarity.

This object of the invention is obtained according to the invention with a method for holding together an electrically non-conductive stack of objects, such as a stack of magazines or foil strips, comprising the steps of:

i) forming the stack of objects; and

ii) applying along at least one stack surface at a distance D at least two regions having a difference in static polarity such that the stack of objects is held together.

The basic insight of the invention is the application at a relatively short distance D to regions having different static polarity. This distance D is generally shorter than the distance in between two surfaces of the stack, such that the electrostatic field force is higher, thereby more firmly holding the stack of objects together. The distance D is dependent on the electrical insulation property between the two regions and the magnitude of the difference in static polarity. Obviously, well defined regions may be applied thereby well defining the static electric forces for holding together the objects of the stack.

When the stack of objects is relatively high, or the stack of objects is to be firmly held together, then it is preferred that a plurality of regions is applied at a distance D.

Required according to the invention is that neighbouring or alternating regents have a difference in static polarity. This difference in static polarity may be the same in between neighbouring regents or may be different in magnitude. Any of the regions may have a static polarity of 0 Volt as long as there is a difference with the neighbouring regent. The difference in static polarity may vary between about 0 to 200 kvolt, such as 5-100 kVolt. The static polarity may be applied by use of an alternating current, a direct current or no current (earthed polarity).

Generally, the distance D between the regions and the static polarity difference between neighbouring regions is selected as to avoid electric discharge. Still, the distance D between the neighbouring regents may vary dependent on the required force for holding together the objects within the stack of objects. The same applied for the difference in the static polarity.

From a practical point of view it is preferred that the distance D between neighbouring regions is constant and/or the static polarity difference between neighbouring regions is constant.

The regions having a difference in static polarity may have any form which allows the erection and maintenance of a static electrical field in the stack of objects between the alternating or neighbouring regents. The regions may have the form of a dot or a blotch. Preferred are regions having an elongated form, such as lines having a width dependent on the application and the form of objects to be held together. It is practical that the regions, when having an elongated form, are mutually running along together and preferably are parallel to one another.

The regions of applied mutually different static polarity have preferably a non-parallel alignment with the stacked objects. For reasons, that at the regents there is no or very small static electrical field and therefore a relatively low force of holding together the stacked objects. In order to avoid a mutual displacement, it is preferred that the regions of different static polarity are not parallel to the object so that there are no places at or between the objects where there is no static electric field for holding the object together.

Although it is sufficient to apply the alternating regents of different static polarity at one surface of the stack of objects, it is preferred for increasing the force of holding together the objects in the stack that at two or more surfaces regents are applied with mutually different static polarities.

The static polarity for a region may be applied by contact with an electrode or by induction with an electrode of a particular distance from the surface of the stack of objects. All dependent on the precision and the location required and dependent on the type of electrode having a soft resilient or hard contact surface.

As indicated here and before the static polarity of the various regents may be applied using an electric charge which may be an alternating charge, a direct charge or zero voltage (earthed).

Another aspect of the present invention relates to an electrically non-conductive stack of objects, such as a stack of magazines or foil strips, comprising a station for a stack of objects, and at least two electrodes for applying along at least one stack surface at a distance D at least two regions having a difference in static polarity such that the stack of objects is held together, and power supplies for the respective electrodes. Although it is indicated that at least two electrodes are used for applying at the various regents and mutually different static polarity, it is theoretically possible to use one electrode for applying the two regents with different static polarity at a surface of the stack of objects.

Various embodiments of the respective electrodes are possible. According to one embodiment the at least two electrodes are incorporated in a non-conductive electrode unit. This allows the use and control and handling with one single electrode unit for applying at a surface the required at least two regents. According to a preferred embodiment the electrodes are applied on the electrode unit. The electrodes are applied on the electrode unit via an application technique, such as by viper-deposition, by slurry-deposition or melt-deposition. Similar techniques may originate from the technology in relation to the making of circuit boards.

According to another preferred embodiment electrodes are applied in an electrode compartment in an electrode unit. In this embodiment the electrode unit made of an insulating material comprises indentations or grooves in which the electrodes are applied. Accordingly, the material in between the electrode compartments functions as an insulator, thereby allowing relatively short distances while applying higher electric charges. Obviously, both type of electrodes may be structured such that the electrode has a hard or resilient surface as required. The electrode unit may be of hard or resilient non-conductive material or provided with a resilient non-conductive top layer.

As indicated above the electrodes are mutually aligned dependent on the relative positions of the regions having different static polarity at a surface of the stack of objects. It is preferred that the electrodes are aligned and the alignments may have the forms of lines, squares, triangles or dots. When aligned, the electrodes are aligned such that the regions do not run in parallel with the stacked objects thereby avoiding as much as possible any undesired de-stacking of the objects or locally too low electric forces for holding together the objects.

A final aspect of the present invention relates to the described electrode unit for using the method and device according to the invention.

Mentioned and other features of the method, device and electrode unit according to the invention will be further illustrated by reference to the different embodiments which are given for illustrative purposes only and not intended to restrict the invention to any extent.

In the drawings are:

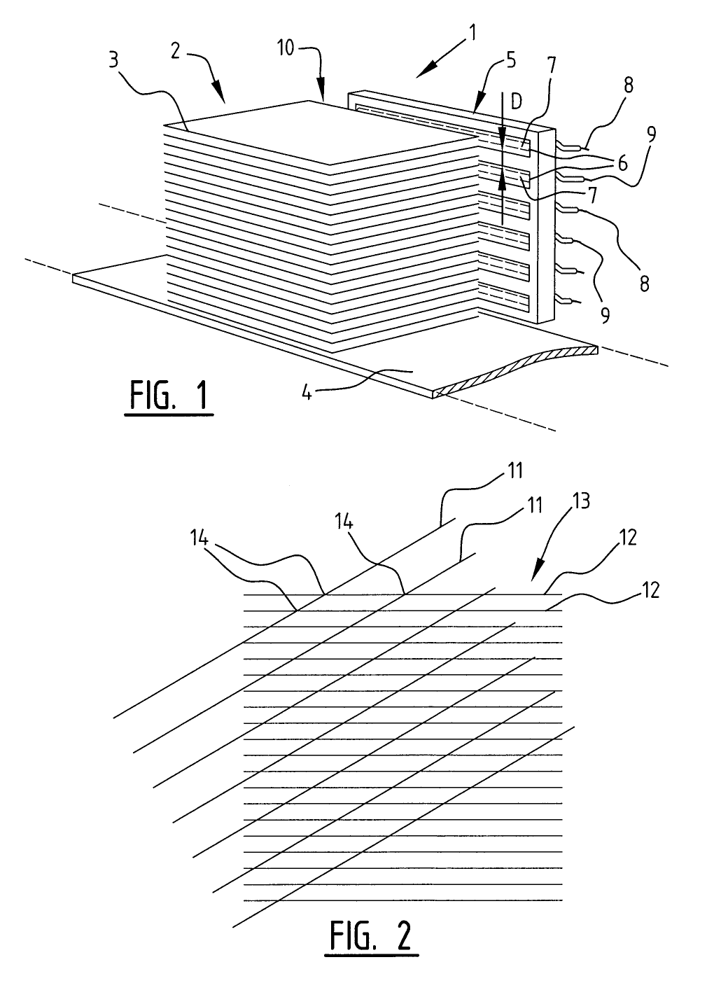

FIG. 1 a respective view of a first device according to the invention;

FIG. 2 shows the alignment of the regents having different static polarity relatively to the stacked objects;

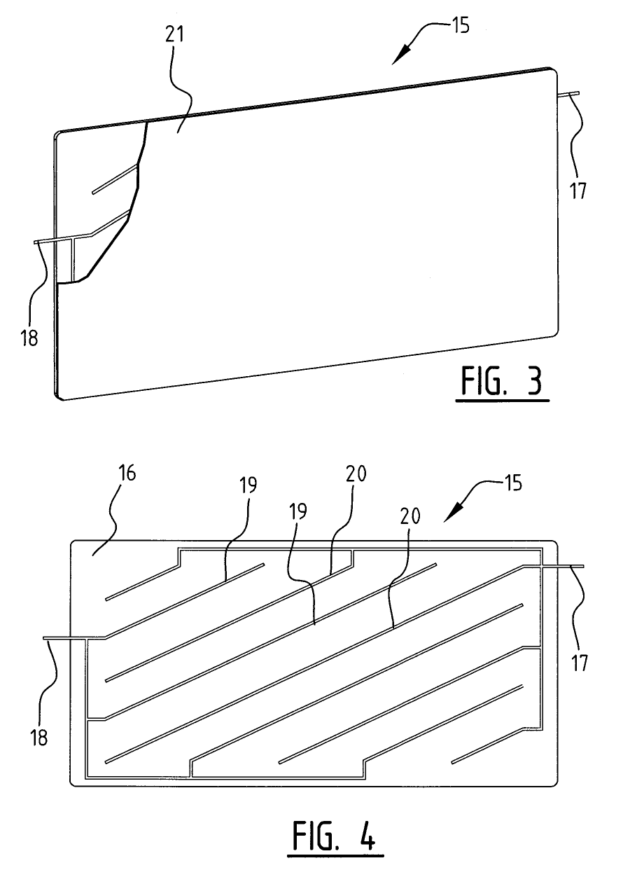

FIGS. 3 and 4 a first embodiment of the electrode unit according to the invention;

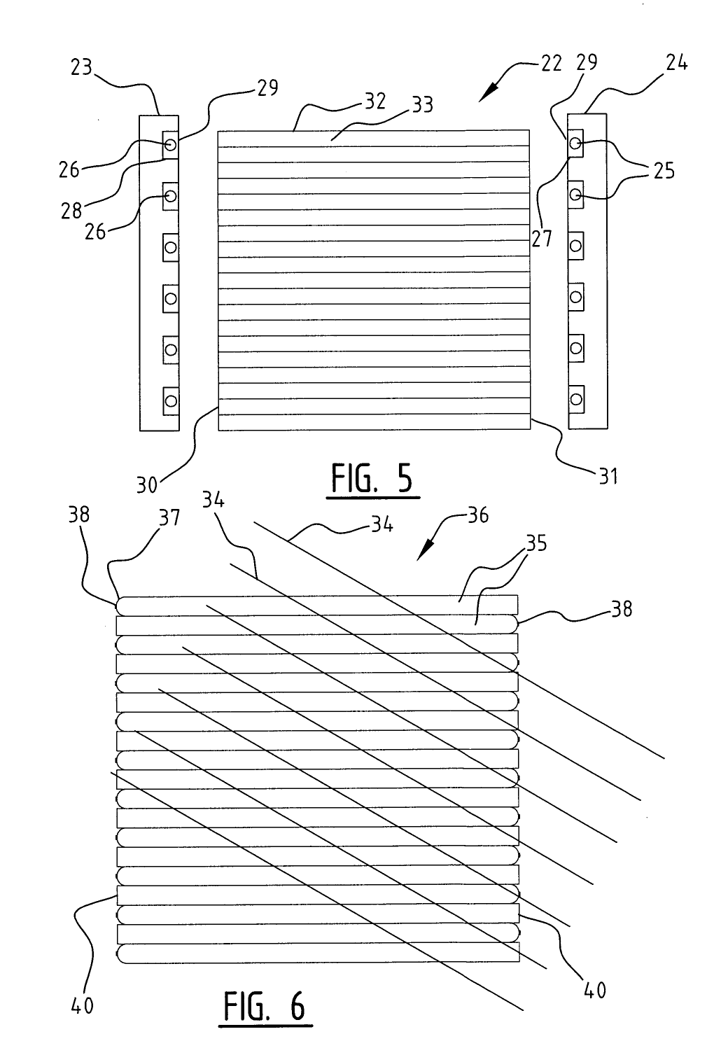

FIG. 5 schematically in side view another device according to the invention;

FIG. 6 another alignment of the regents relative to the stacked object provided with staples; and

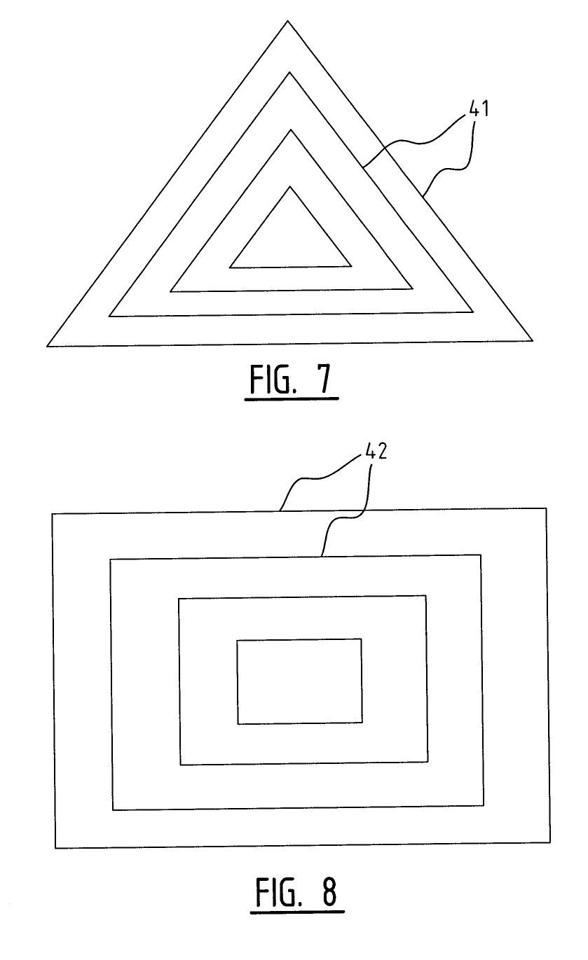

FIGS. 7 and 8 to other patterns of aligned regents used according to the invention for holding together a stack of objects.

FIG. 1 shows a device 1 for holding together a stack of objects 2 comprising sheets 3. The stack 2 is placed on a support 4. Lateral of the stack 2 is positioned an electrode unit 5. The electrode unit 5 comprises a block of electrical insulating material, such as pvc or polyurethane. The block of electric insulating material is provided with parallel grooves 6 in which are provided electrodes 7. The electrodes are connected via connections 8 and 9 to respective electric supplies (not shown). The electrodes are conductive and make contact directly the stack surface 10 for applying six regions having a static polarity which is different in between neighbouring or alternating regents and dependent on the electric charge to which the electrode 7 is connected. In this case the difference in static polarity may be in total 100 kV, 50 kV or 30 kV. The distance D between two neighbouring electrodes 7 varies between 0.5 cm to 10 cm dependent on the required electrical field for holding together the stack of objects, the applied difference in static polarity and the insulating capacity of the electrode unit and of the stack of objects for avoiding electric discharge.

Obviously, it is possible to use the same or additional electrode unit 5 for applying regions having a difference in static polarity at the apposite surface or the other surfaces including the top surface. When applied to the top surface it is preferred that the bottom surface of the stack of objects is having an earth potential.

FIG. 2 shows another alignment of the electrodes 11 relative to the alignment of the objects 12. It is noted that the neighbouring electrodes will have a difference in static polarity. By contact or induction the stack 13 of objects 12 will be provided with regions of different static polarity very similar if not identical to the form and direction of the electrodes 11. In between two neighbouring electrodes 11 there will be an static electric field. Only at the intersections 14 of a region with the objects there will be no static electric field and locally no force for holding together the objects. By the non-parallel alignment of the electrodes 11 and the objects 12, the intersections 14 vary in position such that over the length or surface of the objects 12, there is sufficient static electrical field for holding the objects 12 together.

FIGS. 3 and 4 show another embodiment of the electrode unit 15 of the invention. The electrode unit 15 comprises a electric insulating substrate 16 on which by vapour-deposition have been deposited to electrodes 17 and 18 following a pattern of aligned electrode lines 19, 20 respectively.

The electrodes having a specific resistance of <1000 Ohm are covered by a layer 21 of resilient semi-conductive material having a specific resistance of 10/3-10/12 Ohm. This semi-conductive, elastically resilient layer will deform upon contact with the stack of objects. By intimate contact, static electricity is transferred in a very controlled manner. The semi-conductive material for instance may be formed by impregnated or doped polyurethane foam. The layer may be formed by resin, woven material, non-woven material such as polymer fibres.

FIG. 5 shows another device 22 according to the invention, comprising two electrode units 23 and 24 having electrodes 25 and 26 arranged in grooves 27 and 28, respectively. The electrodes 25, 26 in the grooves 27, 28 are covered by an afore mentioned layer of semi-conductive resilient material in the form of a layer 29.

The neighbouring electrodes 25, 26 will have a difference in static polarity for applying regents of different static polarity on the surfaces 30 and 31 of the stack 32 of objects 33. The applications of the regents on different static polarity may occur by induction over the illustrated difference or by temporarily contacting the electrode units 23 and 24 the with the surfaces 30, 31 respectively.

FIG. 6 shows an alignment of the electrodes 34 relative to the objects 35 of the stack 36. The objects have at the object back 37 one or more staples 38.

When applying the regents of different static polarity using the semi-electrodes 34 on the surfaces 39 and 40, then in the region of a staple 38 the stack will be conductive which results only there and then with a disrupter of the electrical field. The disrupter is local and due to the non-parallel alignment the electrical field generated by the regions of different static polarity is sufficient for maintaining the stack of stapled objects.

Four stacks having a form different from the square to rectangular side surfaces or top or bottom surfaces as disclosed in FIGS. 1, 2, 5 and 6, it is possible to apply adjusted alternative electrodes, preferably mounted in an electrode unit.

FIG. 7 discloses an array of electrodes 41 having the form of triangles. Neighbouring triangular electrodes 41 will have a different static polarity.

Similarly electrodes having a rectangular mutual alignment are illustrated in FIG. 8.

Obviously, when integrating the electrodes in an electrode unit preferably covered with a non-interfering protective layer, the electrode units are optimally suitable and easy to clean after multi-use in a dusty environment.

1. Method for holding together an electrically non-conductive stack of objects, such as a stack of magazines or foil strips, comprising the steps of:
i) forming the stack of objects; and
ii) applying along at least one stack surface at a distance D at least two regions having a difference in static polarity such that the stack of objects is held together.

2. Method according to claim 1, wherein a plurality of regions is applied at a distance D.

3. Method according to claim 1, wherein alternating regions having a difference in static polarity is applied.

4. Method according to claim 1, wherein the distance D between the regions and the static polarity difference between neighbouring regions is selected as to avoid electric discharge.

5. Method according to claim 1, wherein the distance D between neighbouring regions is constant and/or the static polarity difference between neighbouring regions is constant.

6. Method according to claim 1, wherein the regions have an elongated form, preferably mutually parallel.

7. Method according to claim 1, wherein the regions have a non-parallel alignment with the stacked objects.

8. Method according to claim 1, wherein the regions having a difference in static polarity are applied at least two stack surfaces.

9. Method according to claim 1, wherein the static polarity is applied by contact or by induction with an electric charge.

10. Method according to claim 1, wherein the electric charge is an alternating charge, direct charge or 0 Voltage.

11. Device for holding together an electrically non-conductive stack of objects, such as a stack of magazines or foil strips, comprising a station for a stack of objects, and at least two electrodes for applying along at least one stack surface at a distance D at least two regions having a difference in static polarity such that the stack of objects is held together, and power supplies for the respective electrodes.

12. Device according to claim 11, wherein the at least two electrodes are incorporated in a non-conductive electrode unit, made of hard or resilient material or provided with a resilient top layer, which are of non-conductive material.

13. Device according to claim 12, wherein the electrodes are applied on the electrode unit.

14. Device according to claim 12, wherein electrodes are applied in an electrode compartment in an electrode unit.

15. Device according to claim 11, wherein the electrodes are aligned, preferably aligned parallel, having the form of lines, squares, triangles or dots.

16. Electrode unit as defined in claim 12.
